(19) United States
(12) Patent Application Publication
(10) Pub. No.: US 2008/0302544 A1
(43) Pub. Date: Dec. 11, 2008

(54) Fire barrier fabric and related fire protective systems

(76) Inventors: Larry G. Eskind, Tucson, AZ (US); Robert V. Pliskin, Windham, NH (US); Richard Satin, Swampscott, MA (US); Steven Paul Satin, Dracut, MA (US)

Correspondence Address: PROSKAUER ROSE LLP, ONE INTERNATIONAL PLACE, BOSTON, MA, 02110, US

(21) Appl. No.: 11/586,385

(22) Filed: Oct. 25, 2006

(51) Int. Cl. A62C 39/00

(52) U.S. Cl. 169/51

(57) ABSTRACT

A fire barrier fabric for improving the fire-resistance abilities of a fire protective system includes a fabric having an exterior surface and an interior surface, and an intumescent coating disposed on a portion of at least one of the exterior surface or the interior surface. The intumescent coating as disposed on the fabric achieves class A requirements of ASTM E84 standard test and exceeds a three hour burn-through test. The fire protective system can be used to protect cargo on air, ground, or water vehicles, to protect cables, and/or to protect structures or equipment from fire and water damage.

### FIELD OF THE INVENTION

The invention generally relates to fire resistant materials used to coat substrates, such as, for example, fabrics, and which form fire barriers that substantially prevent burn through of the substrate.

### BACKGROUND OF THE INVENTION

Fire resistant materials including intumescents are widely used to provide thermal protection and to increase the fire-resistance characteristics of an underlying substrate. In general, intumescents are materials that undergo a series of chemical reactions when exposed to high heat (e.g., heat in excess of about 400° F.) to form an insulating cellular carbonaceous (e.g., char) layer. The char layer insulates the underlying substrate from conducted heat and thus, prevents or decreases thermal damage to the substrate. In addition, the char layer retards flame spread by hindering the flow of combustible gases about the substrate.

Intumescent materials typically include a catalyst, a blowing agent, and a charring agent that are held together in close proximity by a polymer binder. When high heat is applied to an intumescent material, the catalyst is activated, which initiates a chemical reaction in the charring agent to form a char layer. The applied heat also initiates the decomposition of the blowing agent. As the blowing agent decomposes, non-flammable gases are released into and are captured by the char layer to produce a structure which is a heat insulator (e.g., a cellular carbonaceous layer). As a result of the heat activated chemical reactions, the intumescent layer swells to form the cellular char layer, which substantially protects the underlying substrate from conducted thermal damage such as, for example, thermally induced weakening of the substrate's structural integrity.

A number of disadvantages and limitations exist with respect to known intumescent coating materials. For example, some known intumescent materials have poor adherence to their substrates. As a result, these intumescent materials tend to peel or flake off, thereby leaving the underlying substrate vulnerable to thermal damage. Moreover, some intumescent materials are known to have poor adherence in extreme environments, such as, for example, cold environments (e.g., consistently below 0° F.), corrosive environments (e.g., seawater), or where vibration may be a factor with adhesion (e.g., automotive fire barriers, aircraft fire barriers, aircraft insulation). Some intumescent materials have been known to have poor flexibility. As a result, these intumescent materials can not be used to coat substrates that bend or flex and/or substrates that have complex geometries (e.g., curved surfaces).

Another problem associated with conventional intumescent materials is the amount of intumescent (e.g., cellular char) generated. Typically, a 30 to 250 mil thick intumescent coating generates less than two to five times its initial thickness (e.g., less than an inch) of cellular char when exposed to high heat. Since the insulative properties of the intumescent material are related to the thickness of the cellular char, greater intumescence is preferred (e.g., char lengths of at least 20 to 1600 times its initial thickness). Moreover, conventional intumescent materials tend to be brittle and thus, easily fracture and break away from the substrate.

### SUMMARY OF THE INVENTION

In general, in one aspect, the present invention features an improved fire resistant material. In one embodiment, the improved fire resistant material includes a fire barrier coating material applied to fibrous substrate, such as a substrate formed of fiberglass or a silica glass cloth. In certain embodiments, the improved fire resistant material forms a layer of an infra-red energy reflecting material at an interface between the fire barrier coating and the fibrous substrate when exposed to temperatures of about 375° F. or greater (e.g., 375° F., 380° F., 395° F., 400° F., 410° F., 425° F., 500° F. or more).

In another aspect of the invention, the improved fire resistant material includes a composite structure including a fabric coated with a water-based acrylic, low smoke, low heat release, intumescent fire barrier coating. In general, the intumescent fire barrier coating is a free-flowing water-based polymeric emulsion with a low surface tension and fast drying rate. As a result, the intumescent fire barrier coating adheres well to most substrates and is flexible and durable (i.e., the fire barrier coating resists cracking or peeling off of a substrate during manufacture and use). Due to its polymeric qualities, the intumescent coating, besides being an excellent fire barrier provides a water barrier protection for underlying product, such as cargo. The intumescent fire barrier coating can be applied to any woven or non-woven fabric. For example, the intumescent fire retardant coating can be sprayed or dipped onto a fabric made from glass fibers, metal fibers, natural fibers such as, silk fibers, cotton fibers, wool fibers, wood fibers, or fibers made from leather strips, or synthetic fibers, such as polymer fibers. The fabric can be tightly woven or constrained to provide a substantially dense material (i.e., void space is less than 5 volume percent of the fabric). Alternatively, depending on the substrate, the fabric can have an open woven (e.g., void) structure or a mesh type appearance.

In another aspect, the invention features a fire protection system for cargo (e.g., a fire barrier system for cargo). The fire protection system includes a covering with an intumescent fire barrier coating. The covering includes an exterior surface and interior surface and defines a compartment for housing cargo (e.g., somewhat like the compartment created to house a toaster by a toaster covering). The intumescent coating is disposed on a portion of at least one of the exterior surface or the interior surface of the covering (and may be disposed on both the exterior surface and interior surface) and as disposed on the covering achieves class A requirements of ASTM E84 standard test and exceeds a three hour burn-through test.

Embodiments of this aspect of the invention include one or more of the following features. The covering is made of a tarp including woven or non-woven fibers. For example, the tarp may be a non-woven blanket, a mesh netting, or a piece of tightly woven fabric. The woven or non-woven fibers may be formed of one or more of the following types of fibers, glass fibers, natural fibers, synthetic fibers, and metal fibers. The portion of covering coated may include the entire exterior surface, the entire interior surface, both the exterior surface and interior surface, or a portion corresponding to fabric doors on a metal cargo container. In certain embodiments, the intumescent coating when activated by heat reduces transmission of infra-red radiation to the covering by producing an infra-red reflective (i.e., refractory) layer.

In another aspect, the invention features a fire barrier protection system for cargo including a covering and an intumescent coating. The covering includes an exterior surface and an interior surface and defines a compartment for housing cargo. The intumescent coating is disposed on a portion of at least one of the exterior surface or the interior surface of the covering. The intumescent coating includes a rheology modifier, a binder cross-linking agent, and an intumescent base, which comprises more than about 65 weight percent (e.g., about 66 weight percent, about 70 weight percent, about 75 weight percent, about 80 weight percent, about 85 weight percent, about 90 weight percent, about 95 weight percent or more) of the intumescent coating, includes a binder, a catalyst, a blowing agent, and a charring agent.

Embodiments of this aspect of the invention can include one or more of the following features. The blowing agent used to form the intumescent base can include superfine melamine. In certain embodiments, the intumescent coating can further include a biocide, a fungicide, and/or a solvent, such as, for example, water. The covering of the protection system, in one embodiment, is made of a tarp including woven or non-woven fibers. For example, the tarp may be a non-woven blanket, a mesh netting, or a piece of tightly woven fabric. The woven or non-woven fibers may be formed of one or more of the following types of fibers, glass fibers, natural fibers, synthetic fibers, and metal fibers. In certain embodiments, the tarp may include multiple layers including one or more fabric layers and at least one insulative layer. In other embodiments, the tarp includes a single layer of fabric. The portion of covering or tarp coated with the intumescent coating may include the entire exterior surface, the entire interior surface, both the exterior surface and interior surface, or a portion corresponding to fabric doors on a metal cargo container. In certain embodiments, the intumescent coating when activated by heat reduces transmission of infra-red radiation to the covering by producing a refractory layer.

In another aspect, the invention features a fire protection system for structures (e.g., a fire barrier to prevent the burn through of structures). The fire protection system includes a rollup fabric door defining a front exterior surface and a back exterior surface and an intumescent coating disposed on at least one of the front exterior surface or the back exterior surface. The rollup fabric door of the fire protection system is connected to a mechanism (e.g., a motor) for deploying the rollup fabric door from a rollup contained state to an unrolled state. The intumescent coating includes a rheology modifier, a binder cross-linking agent, and an intumescent base, which comprises more than about 65 weight percent (e.g., about 66 weight percent, about 70 weight percent, about 75 weight percent, about 80 weight percent, about 85 weight percent, about 90 weight percent, about 95 weight percent or more) of the intumescent coating. The intumescent base includes a binder, a catalyst, a blowing agent, and a charring agent.

Embodiments of this aspect of the invention can include one or more of the following features. The rollup fabric door can include an insulating layer disposed between the front exterior surface and the back exterior surface. The fire protection system described above can further include a smoke or fire detector in electrical communication with the mechanism for deploying the rollup fabric door.

In a further aspect, the invention features a fire barrier gasket for sealing a gap between two adjacent members. The fire barrier gasket includes a fibrous body (e.g., a fiberglass form) that when compressed between two adjacent members fills the gap and an intumescent coating disposed on an exterior surface of the fibrous body. The intumescent coating includes a rheology modifier, a binder cross-linking agent, and an intumescent base, which comprises more than about 65 weight percent (e.g., about 66 weight percent, about 70 weight percent, about 75 weight percent, about 80 weight percent, about 85 weight percent, about 90 weight percent, about 95 weight percent or more) of the intumescent coating. The intumescent base includes a binder, a catalyst, a blowing agent, and a charring agent.

In another aspect, the invention features a fire barrier wrap for protecting electrical wires. The fire barrier wrap includes a support layer, an intumescent coating, and an attachment means for securing the support layer about one or more electrical wires. The support layer of the fire barrier wrap is formed of fibers (woven or non-woven) and includes an interior surface and an exterior surface. The intumescent coating is disposed on at least one of the interior surface of and the exterior surface of the support layer and maintains electrical continuity of the one or more electrical wires for at least five minutes at 2000° F.

In a further aspect, the invention features a fire protection system including a fibrous substrate (e.g., fiberglass sheet, a silica glass cloth, or a polymer reinforced carbon fiber sheet) and a fire barrier coating. The fibrous substrate includes an exterior surface and an interior surface. The fire barrier coating is disposed on a portion of at least one of the exterior surface or the interior surface of the fibrous substrate. The fire barrier coating includes a rheology modifier, a binder cross-linking agent, and an intumescent base, which comprises more than about 65 weight percent (e.g., about 66 weight percent, about 70 weight percent, about 75 weight percent, about 80 weight percent, about 85 weight percent, about 90 weight percent, about 95 weight percent or more) of the intumescent coating, includes a binder, a catalyst, a blowing agent, and a charring agent.

In another aspect, the invention features a fire protection system including a fibrous substrate and a fire barrier coating. The fibrous substrate includes an exterior surface and an interior surface. The fire barrier coating is disposed on at least one of the exterior surface or the interior surface of the substrate to form an interface between the fibrous substrate and the fire barrier coating. The fire barrier coating reacting when exposed to a temperature of greater than about 375° F. (e.g., 375° F., 380° F., 395° F., 400° F., 410° F., 425° F., 500° F. or more) to form a layer of an infra-red energy reflective material at the interface.

In general, the intumescent fire barrier coating and protection systems described above can include one or more of the following advantages. In general, the fire barrier coatings of the present disclosure adhere well to substrates. As a result, the intumescent fire barrier coating can be applied to substrates that are used in extreme environments (e.g., cold environments, corrosive environments, environments which include constant vibration) without peeling away or separating from the substrate. The fire barrier coating is also flexible and thus, can be used to coat substrates that bend or flex or have complex geometries, thereby allowing resulting protection systems to be used in active environments. In addition the intumescent fire barrier coating remains intact on a substrate even during manufacture of a fire protection system. That is, the intumescent coating does not peel or crack off the substrate during cutting of an underlying fabric or sewing or attachment of two pieces of fabric together to form a fire barrier protection system. Another advantage of the fire barrier coating and protection systems is its increased insulative properties. When subjected to a heat of 400° F. or more, the fire retardant coating generates an increased yield of cellular char in comparison to conventional intumescent materials and coatings. For example, a 10 mil thick coating of the intumescent material, made in accordance with the present invention, can generate as much as two inches of cellular char when subject to a flame from a propane torch, whereas 30 to 250 mils of conventional fire retardant materials tend to generate less than an inch of cellular char. As a result of the increase in char yield, the intumescent fire barrier materials of the present invention is able to better insulate and thus thermally protect the underlying fabric.

In addition to the fire barrier coating's ability to thermally protect the underlying fabric, the intumescent fire barrier coating described above can also protect the fabric from moisture damage. The intumescent fire barrier material is durable and thus seals off the underlying substrate, preventing fluids from reaching the fabric surface. Also, the intumescent fire barrier coating is dirt resistant and when cleaned with water is able to protect the underlying fabric from water damage.

Another advantage of the present invention is that the intumescent fire barrier coating when subjected to high heat (e.g., above 400° F. or more) does not emit toxic vapors.

A further advantage provided by the fire protection systems and fire barriers described herein relates to environmental concerns. Specifically, due to the fire protection systems' ability to limit flame spread and increase burn through times, less materials, when protected by a fire protection system, will be destroyed or damaged in a fire. As a result, the amount of waste that ultimately resides in a landfill and/or impacts the environment will be minimized.

The foregoing and other aspects, features, and advantages of the disclosure will become more apparent from the following description and from the claims.

### BRIEF DESCRIPTION OF THE DRAWINGS

In the drawings, like reference characters generally refer to the same parts throughout the different views. Also, the drawings are not necessarily to scale, emphasis instead being placed upon illustrating the principles of the disclosure.

FIG. 1A is an illustration of a fabric substrate coated with an intumescent fire barrier coating in accordance with an embodiment of the invention prior to flame exposure.

FIG. 1B is an illustration of the fabric substrate and the intumescent fire barrier coating of FIG. 1A after flame exposure.

FIG. 2A is an illustration of a fire protection system for cargo.

FIG. 2B is an enlarged cross sectional view of a portion of the fire protection system labeled A in FIG. 2A.

FIGS. 3A and 3B are illustrations of a fire protection system for structures including a fabric rollup door. In FIG. 3A the fabric rollup door is in a contained or unactivated state. In FIG. 3B the fabric rollup door has been deployed to an unrolled state.

FIGS. 4A and 4B are a cross-sectional views of a fire barrier wrap for protecting electrical cables.

FIG. 5 is a perspective view of a fire barrier gasket including a fabric substrate coated with an intumescent fire barrier coating in accordance with an embodiment of the disclosure.

FIG. 6 is a flow diagram of a method of manufacturing a fire protective system in accordance with an embodiment of the invention.

### DETAILED DESCRIPTION OF ILLUSTRATIVE EMBODIMENTS

An intumescent fire barrier material used to form an intumescent coating on a fabric includes an intumescent base, which comprises about 65 weight percent or more of the fire barrier material. The intumescent base is heat activated such that upon exposure to heat in excess of about 400° F., the intumescent coating swells to form a cellular char layer that substantially protects an underlying fabric substrate from thermal damage. In general, the intumescent coating of the present invention provides a higher yield of cellular char when activated by heat than conventional fire retardant materials. As a result, intumescent coated fabrics and resulting fire barrier protection systems of the present invention provides greater insulative properties and increased thermal protection in comparison to conventional intumescents.

To form a fire protection system, the intumescent fire retardant material is deposited on a flexible fabric that may or may not have its own fire resistant capabilities. In general, the flexible fabric is formed of woven fibers or non-woven fibers to form a tarp or fire blanket. Exemplary fiber materials include metal fibers (e.g., aluminum, copper, steel), glass fibers (e.g., fiberglass), natural fibers (e.g., cotton fibers, silk fibers, wool fibers, wood fibers, strips of leather used as fibers), and synthetic fibers (e.g., Kevlar® fibers, Tedlar® fibers, which are both available from DuPont Corporation). The fibers may be woven or compressed to form a substantially solid structure having little to no void space within the fabric. Alternatively, the fibers may be woven or compressed to form a substantially porous structure (e.g., a screen, a loose weave metal fabric). The intumescent fire barrier material can be deposited on to the fabric to form an intumescent coating using any known method, such as for example, spraying, dipping, rolling, gap coating (e.g., knife over roll, floating knife), scrape coating, soaking, brushing, scrape coating, knife over roll and transferring. The fire barrier material can be deposited on a single surface of the fabric or multiple surfaces (e.g., two or more surfaces) of the fabric. In embodiments, the intumescent fire barrier material can be at least partially embedded within the substrate. For example, the intumescent coating can be disposed within openings between two fibers in a woven fabric.

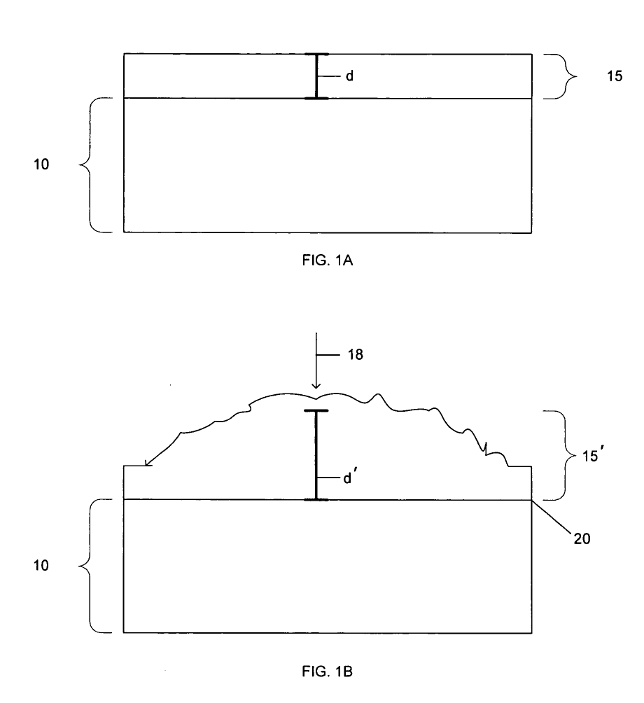

FIGS. 1A and 1B illustrate a fabric 10 including an intumescent coating 15 disposed on a top or exterior surface of the fabric 10. After deposition of the intumescent coating 15, but before exposure to a heat source 18 (e.g., a flame) having a temperature of 400° F. or more, the intumescent coating 15 has an initial thickness labeled d in FIG. 1A. In certain embodiments, d is within a range of about 1 mil to about a half inch. In other embodiments, d, is within a range of about 0.002 to 0.010 inches. During exposure to the heat source 18, the intumescent coating 15 expands to form a cellular char layer 15′. (See, FIG. 1B). The cellular char layer 15′ has a thickness d′ which is at least 5 times greater than d. For example, in one embodiment, the initial thickness d is 10 mils and after exposure to a flame from a propane torch (e.g., flame temperature about 2000° F.) for 5 minutes, d′ has a thickness of four inches.

During exposure to heat source 18, the intumescent coating 15 not only intumesces to form char layer 15′ but also has been observed to form an infra-red energy reflective layer (i.e., a refractory layer) deposited along an interface 20 between the fabric 10 and the char layer 15′. It is believed that this refractory layer reflects radiant heat (e.g., infra-red radiation) that normally would penetrate through a char layer away from the fabric 10, thereby increasing the fire and burn through protection of the fabric 10 coated with the intumescent coating 15.

The intumescent coating 15 is made from a material that includes an intumescent base material, a rheology modifier, and a binder cross-linking agent. The intumescent base material, is a heat activated material that reacts to initiate formation of the cellular char layer 15′. The intumescent base material includes a binder, a catalyst, a blowing agent, and a charring agent.

In general, the binder is a polymer material that holds the catalyst, blowing agent and charring agent together. Examples of binders that can be used to form the intumescent base material include acrylic binders, such as, for example, Multilobe 200 (Rohm and Haas, Philadelphia, Pa.), and Rhoplex TR 38 HS (Rohm and Haas, Philadelphia, Pa.). In some embodiments, the binder comprises about 35 weight percent to about 75 weight percent of the intumescent base material (e.g., 45 wt %, 50 wt %, 55, wt %, 60 weight %, 65 wt %).

The catalyst activates the charring agent to form the char layer. In certain embodiments, the catalyst includes a phosphorus source, which decomposes upon the application of a heat source having a temperature of at least about 400° F. As the phosphorus source decomposes, it releases phosphoric acid that causes dehydration of the charring agent, thereby producing a carbon char. Examples of catalysts include pyrophosphates, such as for example, melamine pyrophosphates, and polyphosphates, such as for example, ammonium polyphosphate or amine polyphosphate. Exemplary ammonium polyphosphates include Exolit AP 412, AP 422, AP 423, and AP 462, which are commercially available from Clariant (Charlotte, N.C.). In general, the catalyst comprises about 10 weight percent to about 20 weight percent (e.g., 14 wt %, 15 wt %, 16 wt %) of the intumescent base material.

In general, the charring agent is a material that includes a carbon source. In embodiments, the charring agent will dehydrate upon interaction with an acid, such as a phosphoric acid, to form a char layer. Examples of charring agents include pentaerythritol, such as, for example PE-200 (Perstorp Polyols, Inc., Toledo, Ohio), dipentaerythriol, polyalcohols, and polyurethane. Typically, the charring agent forms between about 5 weight percent to about 15 weight percent (e.g., about 7 weight percent, about 10 weight percent, about 12 weight percent) of the intumescent base material.

In general, the blowing agent also decomposes upon heat exposure. As the blowing agent breaks down, non-flammable gases are released into the char layer. Without wishing to be bound by theory, it is believed that these gases cause the char layer to foam, thereby producing a cellular structure within the char layer. Examples of blowing agents include melamine, such as, for example superfine melamine powder (DSM Melamine Americans, Inc., Addis, La.), urea, dicyandiamide, guanidine, and glycine. The intumescent base material typically includes about 10 weight percent to about 15 weight percent of one or more blowing agents (e.g., the intumescent base material includes 12 wt % blowing agent, the intumescent base material includes 13 wt % blowing agent, the intumescent base includes 14 wt % blowing agent).

The rheology modifier and the binder cross-linking agent provide the fire barrier material with a consistency that allows the intumescent fire barrier layer to adhere to the substrate 10. In general, the rheology modifier is an additive that effects the viscosity of a base material (e.g., the material forming the intumescent coating 15). Examples of rheology modifiers include colloids and starches. The binder cross-linking agent is a material that initiates polymerization of the binder within the intumescent base material and thus, is selected based upon the type of binder used within the intumescent base material. Examples of binder cross-linking agents include acrylic cross-linking agents, such as, for example, butylated melamine formaldehyde cross-linking agents. In general, the fire barrier material forming the intumescent coating can include between 0.1 weight percent to about 15 weight percent of the rheology modifier (e.g., about 0.5 weight percent to about 5 weight percent) and between 1 weight percent to about 20 weight percent of the binder cross-linking agent (e.g., about 2 weight percent to about 10 weight percent).

In some embodiments, the material forming the intumescent coating 15 can further include conventional additives, such as, for example, fungicides, biocides, pigments, stabilizers, and silica particles. In general, these additives will comprises less than about 20 weight percent of the material forming the intumescent coating 15.

Certain embodiments of the material forming the intumescent coating 15 further include a solvent, such as, for example, water, to aid in mixing all of the ingredients of the fire retardant material together and/or to modify the consistency of the fire retardant material.

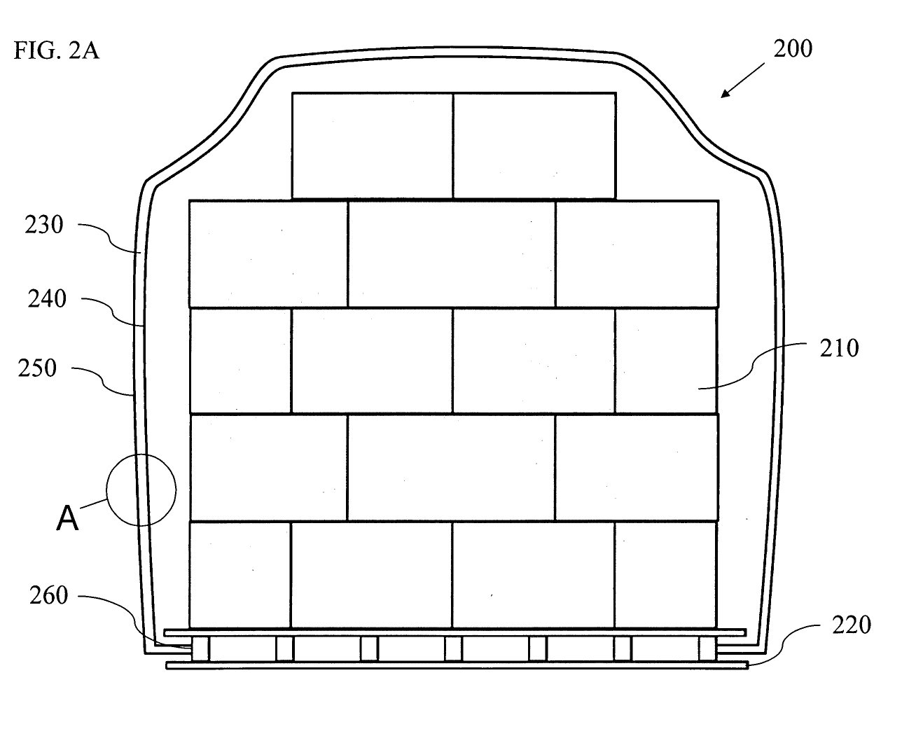

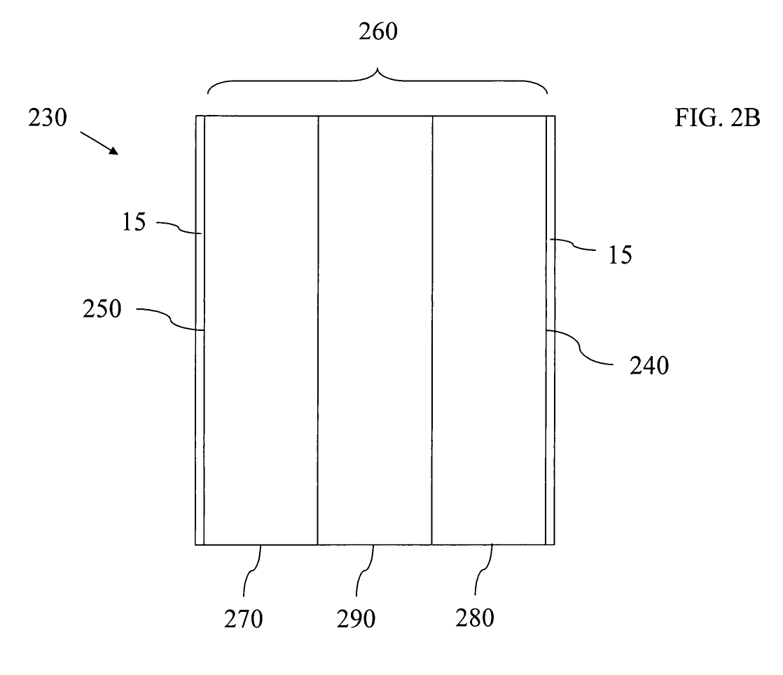

FIG. 2A illustrates an exemplary fire barrier protection system 200 for cargo 210. After loading the cargo 210 onto a pallet 220, a fire barrier fabric 230 can cover the cargo 210 in its entirety as shown in FIG. 2A or can be provided as a fabric container door for a box type cargo container (not shown). The fire barrier fabric 230 has an interior 240 surface, which faces the cargo 210 and an exterior 250 surface, which faces the environment. The fire barrier fabric 230 can be secured to the pallet 220 at an attachment point 260 by means including fasteners, ties, or adhesives. In some embodiments, the fire barrier fabric 230 covers the cargo 210 and the pallet 220. In certain embodiments, the fire barrier fabric 230 can also form a water barrier, protecting the cargo 210 from moisture.

FIG. 2B illustrates an exemplary enlarged cross sectional view of a portion of the fire barrier protection system 200 labeled A in FIG. 2A. In this embodiment, the fire barrier fabric 230 is formed of a tarp 260. The tarp 260 includes several layers of materials, including a first layer 270 of fabric and a second layer 280 of fabric, which surround a third layer 290 of insulating material (e.g., heat insulating material, such as, fiberglass insulation, or water insulating material, such as plastic). The first layer 270 of fabric and the second layer 280 of fabric can be formed of either identical or different materials. In some embodiments, the tarp includes one, or optionally more, layers of material. The fire barrier fabric 230 has an interior 240 surface and an exterior 250 surface. The intumescent coating 15 can be applied to one or both of the interior 240 surface and the exterior 250 surface.

In general, fabrics coated with the intumescent coating 15, such as, for example, the fire barrier fabric 230, meet all requirements for class A under ASTM 84 “Test Method for Surface Burning Characteristics of Building Materials” (also referred to Underwriters Laboratory Test UL 723). In order to achieve class A status, a tested material must be rated between 0 and 25 on a 0 to 100 point scale, where 0 is equivalent to no flame spread and 100 is equivalent to a highly ignitable material. Fabrics coated with a 0.001 inch to 0.010 inch intumescent coating 15 have achieved a rating of 10 and thus fall within class A requirements.

The fire barrier fabric 230, in addition to achieving class A status, has also surpassed the Federal Aviation Administration's (FAA) 3 hour burn-through test for cargo (FAR 25.853). In this test, the fire barrier fabric 230 of the fire barrier protection system 200 prevented a fire burning within the cargo 210 from burning through the fire barrier protection system 200 for over three hours. In fact in some embodiments, the fire barrier protection system 200 prevented burn through for over 9 hours.

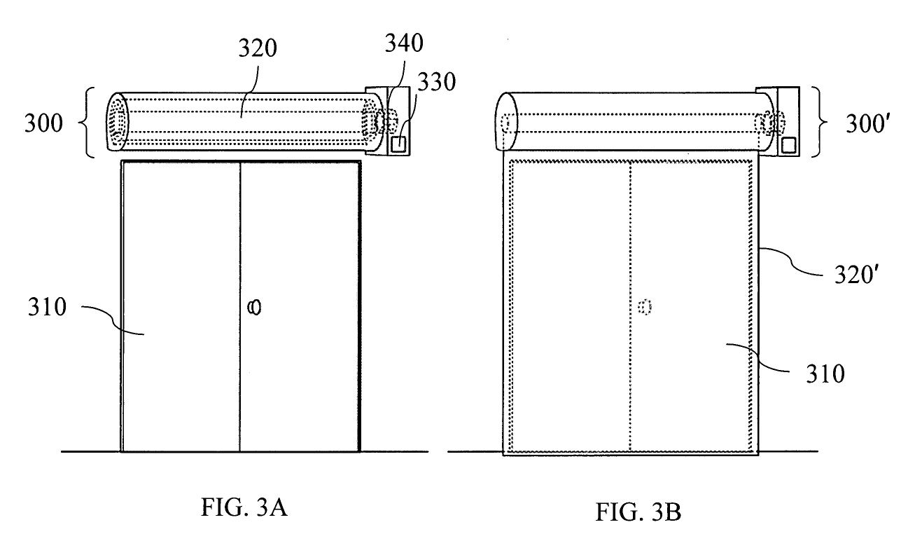

FIGS. 3A and 3B illustrate an exemplary fire barrier protection system 300 for structures including a door 310. The fire barrier protection system 300 is mounted proximally to the door 310. The fire protection system 300 houses a fire barrier fabric 320, which includes the intumescent coating 15 on at least one of its exterior surfaces.

The fire protection system 300 also includes a fire sensor 330 (e.g., a smoke detector or thermometer) to anticipate and/or detect a fire, and a mechanical system 340 (e.g., a motor) to deploy the fire barrier fabric 320 upon anticipation and/or detection of a fire. FIG. 3B illustrates the exemplary fire protection system 300′ in a deployed state. The fire barrier fabric 320′ is deployed to cover and protect the door 310 from fire.

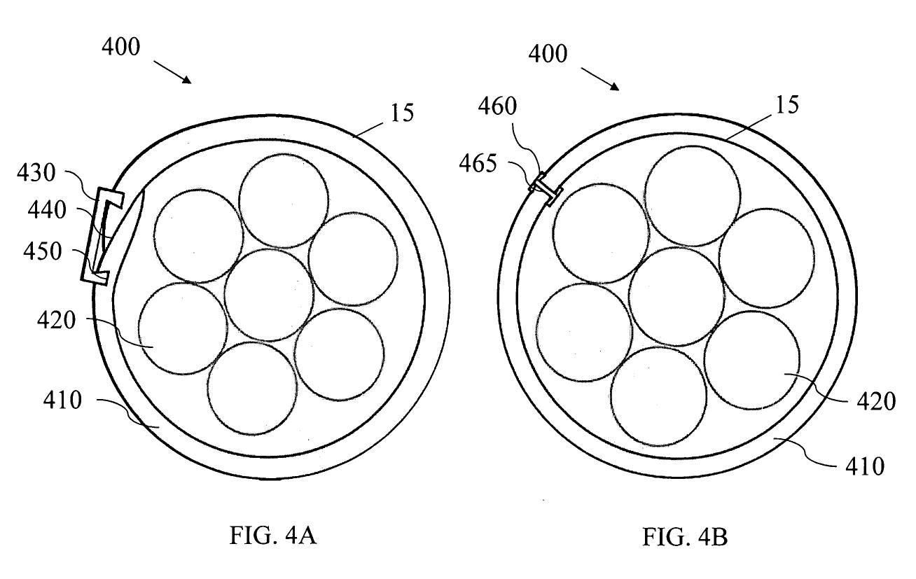

FIG. 4A illustrates a cross-sectional view of an exemplary embodiment of a fire barrier wrap 400 for protecting cables. A fire barrier fabric 410 including the intumescent material 15 disposed on at least one of its surfaces is wrapped around a bundle of cables 420 to protect them from thermal and/or water damage. In the embodiment illustrated in FIG. 4A, the fire barrier fabric 410 is secured by a bracket 430. The fire barrier fabric 410 can also be secured by adhesive at an interface 440 between the fire barrier fabric 410 and/or an interface 450 between the fire barrier fabric 410 and the bracket 430.

FIG. 4B illustrates a cross-sectional view of another exemplary embodiment of a fire barrier wrap 400 for protecting cables. The fire barrier fabric 410 shown in this embodiment includes the intumescent coating 15 on its interior surface (i.e., cable 420 facing surface) to prevent a flame from escaping from the interior region of the wrap 400 including the cables 420. The fire barrier fabric 410 is secured about the bundle of cables 420 by a bracket 460. The fire barrier fabric 410 can also be secured by adhesive at an interface 465 between the fire barrier fabric 410 and the bracket 460. In other embodiments, the wrap 400 can be a circuit box in which the interior of the circuit box is coated with the intumescent coating 15 to prevent or at least increase the time needed for a fire or spark from within the circuit box to burn through the circuit box.

In general, fire barrier wraps 400 are used to maintain safety of electrical equipment in the event of a fire or water damage. For example, fabric 410 helps to prevent flame spread and thus, increases the amount of time needed to achieve burn-through of wrap 400. As a result, electrical continuity in cables 420 is maintained for a longer period of time in the case of a surrounding fire, thereby preventing damage to electrical equipment and mechanical action controlled by signals traveling in cables 420.

For example, a fire barrier wrap 400 including the intumescent coating disposed on its exterior surface prevents flame spread as evidenced by a recorded 1700° F. difference across wrap 400. That is, thermocouples positioned adjacent to the exterior surface of wrap 400 subjected to a flame recorded a temperature of 2000° F., whereas thermocouples positioned in the interior of the wrap 400 near cables 420 recorded a temperature of 300° F. As a result, the wrap was able to effectively prevent flame spread to the cables 420 and thus maintained electrical continuity.

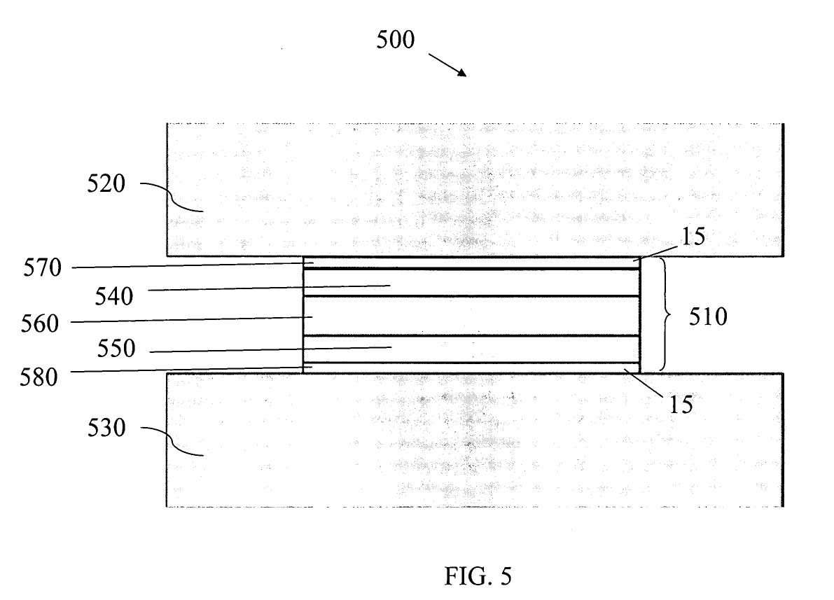

FIG. 5 illustrates an exemplary perspective view 500 of a fire barrier gasket 510 including a fabric substrate coated with an intumescent fire barrier coating, such as the intumescent materials described above. The gasket 510 is positioned between a first element 520 and a second element 530 to form a fire barrier seal. The gasket 510 includes several layers of materials including a first layer 540 of fabric and a second layer 550 of fabric, which encapsulate a third layer 560 of insulating material. The first layer 540 of fabric and the second layer 550 of fabric can be formed of either identical or different materials. In some embodiments, the gasket only includes one, or optionally more, layers of fabric or material. The fire barrier gasket 510 has a first surface 570 and a second surface 580, which can contact the first element 520 and the second element 530, respectively to form a fire barrier seal. The intumescent coating 15 can be applied to one or both of the first surface 570 and the second surface 580.

In certain embodiments, the gasket 510 surpasses the FAA's 5 minute burn through test (FAR 25.853). That is, the gasket 510 can withstand and surpass 5 minutes of exposure to a 15.35 Btu/(ft²-s) flame at 1935° F. applied to one of the first or second elements 520 or 530 without damaging gasket 510 or allowing the flame to pass therethrough.

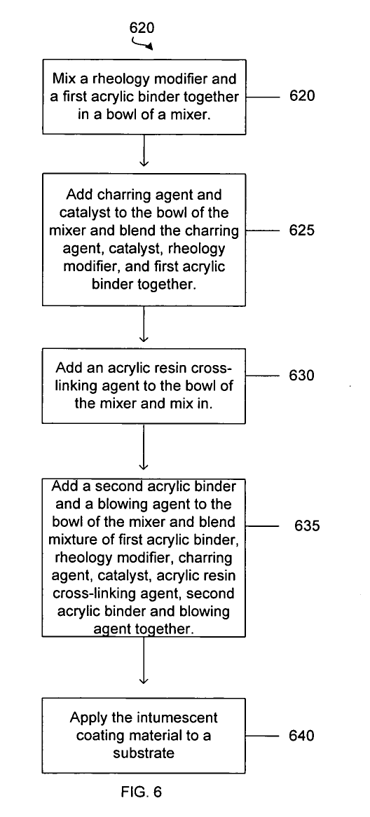

Referring to FIG. 6, a method 600 for manufacturing the material forming the intumescent coating 15 includes at least four steps. As shown in step 620, the material forming the intumescent coating is manufactured by mixing a rheology modifier and a first binder (e.g., a first acrylic binder) together within a bowl of a mixer, such as, for example, a Cowles Blade mixer commercially available from Hockmeyer Equipment Manufacturing, Elizabeth City, N.J. In some embodiments, the first binder is added to the bowl of the mixer and is premixed at a low or medium speed, prior to adding the rheology modifier to form a first mixture. In certain embodiments, additives, such as a biocide, and/or a fungicide can also be added to the mixing bowl to form the first mixture.

As shown in step 625, a charring agent and a catalyst are added to the mixing bowl containing the first mixture. The mixer is set to a slow speed and the ingredients are mixed together to form a second mixture. In certain embodiments, the charring agent and catalysts are added in an alternating fashion as the mixer is combining the ingredients together. For example, a 50 gram scoop can be used to add 50 grams of the charring agent followed by 50 grams of the catalyst until the all of the charring agent and catalyst used in the intumescent coating material (e.g., a total of about 4500 grams) is added. While the charring agent and the catalyst materials are being added to the mixing bowl, the speed of the mixer can be increased so that a vortex is maintained and proper distribution of all of the ingredients is achieved. In certain embodiments, after adding all of the charring agent and the catalyst to the mixing bowl, the mixer continues to mix the second mixture together to ensure distribution of the ingredients (e.g., mixed for another five to ten minutes).

Referring to step 630, a cross-linking agent, such as an acrylic resin cross-linking agent is added to the second mixture to cure the first binder and to form a third mixture. The third mixture is blended in the mixer until a substantially uniform consistency is achieved.

In step 635, a second binder (e.g., a second acrylic binder) and a blowing agent are added to the third mixture. The mixer is set to a medium or slow speed and the ingredients are combined together to form the fire intumescent coating material. This material is blended together until a substantially uniform consistency is achieved. In certain embodiments, the second binder and blowing agent are premixed in a clean mixer on slow to medium speed prior to being added to the third mixture. In certain embodiments, the second binder can be formed of the same material(s) as the first binder (e.g., the first binder and the second binder can be substantially identical).

In some embodiments, the intumescent coating material is passed through a mesh, such as a 150-mesh bag, to filter out any residual clumps, prior to being deposited on a fabric. In certain embodiments, a solvent (e.g., water) can be added to the intumescent coating material to modify its consistency. In some embodiments, the consistency of the intumescent coating material is modified so that the coating 15 has greater adherence to the fabric 10 (e.g., surface tension of the material is decreased). In certain embodiments, the consistency of the intumescent coating material is modified to aid in the application of the intumescent material (e.g., increase the spreadability or sprayability of the intumescent material) on an underlying fabric.

In step 640, the intumescent coating material is applied to a substrate, such as a fabric (e.g., 7678 fiberglass sheet available from BGF Industries of Greensboro, N.C., an OmniSil silica cloth product number OS600 or OS300 available from Thermal Materials Systems, Inc. of Park, Nev., or a QuakeWrap epoxy carbon fiber sheet available from QuakeWrap, Inc. of Tucson, Ariz.) to form a fire barrier material. For example, the intumescent coating material can be deposited on to a desired fabric to form a coating having a thickness of 1 mil to about a half an inch. In one embodiment, the thickness of coating 15 is between about 0.002 inches and 0.01 inches. To deposit the coating any technique may be used include a floating knife or knife over roll technique. In other embodiments, spraying, dipping, extrusion or slot die-coating techniques are utilized to form the coating 15 on fabric 10. In general, after the coating 15 is deposited, the fabric 10 with coating 15 is allowed to dry for a time period of about 10 minutes to 5 hours. In certain embodiments, the fabric 10 with coating 15 may be placed under a low temperature (320° F. or less) heat source to dry the coating 15 and underlying fabric 10. Once dry the fabric 10 with coating 15 may be cut and sewn to form coverings, wraps, or other fire protection systems such as the embodiments shown in FIGS. 2A, 3A, 3B, 4A, 4B, and 5. In general, the coating 15 adheres well to fabric 10 and does not crack or flake off of fabric 10 during cutting, or sewing steps. In addition to being cut or sewn without worry of the coating 15 detaching, the fabric 10 with coating 15 can be colored or printed on to enhance its appearance or to provide a user with operating instructions. Coloring or printing on the dried coating 15 does not degrade the fire retarding capabilities of the material.

### EXAMPLES

The following examples are provided to further illustrate and to facilitate the understanding of the invention. These specific examples are intended to be illustrative of the invention and are not intended to be limiting.

### Example 1

An intumescent fire barrier coating material was prepared by mixing 2750 grams of Multilobe 200 acrylic binder (Rohm and Haas, Philadelphia, Pa.) together with 2555 grams of superfine melamine (DSM Melamine Americas, Inc., Addis La.) in a Cowles Blade mixer (Hockmeyer Equipment Manufacturing, Elizabeth City, N.J.). The combination of Multilobe 200 and superfine melamine was prepared by adding the Multilobe 200 to the bowl of the mixer, setting the mixer speed to slow, followed by slowing adding the superfine melamine. The speed on the mixer was increased while the superfine melamine was added to the mixing bowl to maintain a vortex and good mixing action. After all of the superfine melamine was added, the combination of Multilobe 200 and superfine melamine was further mixed together for 5 minutes on slow speed.

Using a clean mixer and mixing bowl, 8240 grams of Multilobe 200 (Rohm and Haas, Philadelphia, Pa.) was mixed at slow speed. To the Multilobe 200, 180 grams of a rheology modifier (Colloid 675, Kemira Chemicals, Inc., Kennesaw, Ga.) 15 grams of a biocide (Dowicil 75, Dow Chemical, Washington D.C.) and 30 grams of a fungicide (Napcodide N-40-D, Cognis Corporation, Ambler, Pa.) was added. The combination of ingredients was mixed together on slow speed for two minutes to form the first mixture.

To the first mixture, 1940 grams of a charring agent (PE-200, Perstorp Polyols Inc., Toledo, Ohio) and 2975 grams of a catalyst (Exolit AP-422, Clariant, Charlotte, N.C.) were added one scoop at a time in an alternating fashion while the mixer was initially set on a slow speed. The speed of the mixer was increased during mixing to maintain a vortex while the charring agent and the catalyst were being added. After the final scoop of the catalyst was added, the second mixture (e.g., the mixture including Multilobe 200, Colloid 675, Dowicil 75, Napcodide N-40-D, PE-200, and Exolit AP-422) was blended together for five minutes at the slow speed setting.

After blending the second mixture for 5 minutes, 695 grams of an acrylic binder (Cymel 1158, Cytec Industries, Inc., West Paterson, N.J.) was added to the second mixture. The Cymel 1158 was blended into the second mixture on a slow speed until the resulting mixture had a substantially uniform consistency (about 5 minutes).

Finally, the combination of Multilobe 200 and superfine melamine was added to the mixture including Multilobe 200, Colloid 675, Dowicil 75, Napcodide N-40-D, PE-200, Exolit AP-422, and Cymel 1158. The combined mixture was blended until substantially uniform on a low to medium speed to obtain a consistent blend. The blended mixture was filtered through a 150 mesh bag into a clean 5 gallon plastic pail. To which, 646 grams of water was added to modify (e.g., decrease) the viscosity of the intumescent fire barrier coating material.

### Example 2

The toxicity of the intumescent fire barrier coating material as prepared in Example 1 was measured using the Naval Engineering Standard (NES) 713 Toxicity Test. To conduct the test, a 25 gram sample of the fire barrier material was placed in furnace having a maximum temperature of 1050° C. with continuous monitoring of flame temperature with a thermocouple. The test was conducted at an ambient temperature of 59.3° F., 33% relative humidity, a barometric pressure of 30 in. Hg. The toxicity index of the sample was measured to be 11.9, and the sample emitted the following amounts of gases: 0 ppm of H₂S, 57.7 ppm of SO₂, 121.6 ppm of HCN, and 357.4 ppm of HCL.

### Example 3

A 5.7 gram specimen of the intumescent fire barrier coating material as prepared using the method described in Example 1 and was placed in a cone calorimeter. The specimen was tested according to ASTM E1354 with a heat flux of 35 KW and an exhaust flow rate of 34.7 g/s. This specimen was conditioned at an ambient temperature of 23° C. and a relative humidity of 50% prior to testing. The results of the ASTM E1354 test as collected on three separate specimens were as follows: the time to sustained flame was 8 seconds, the THRR was 0.8 MJ/m², the average effective heat of combustion was 5.1 MJ/KG, the mass of the specimen after the test was 3.650 grams, the average HRR at 60 seconds was 12.60 KW/m², the average HRR at 180 second was 4.20 KW/m², the average HRR for 300 seconds was 2.52 KW/m², and the PHRR was 99.35 KW/m². Also, it was observed that the specimens self-extinguished at 17 seconds into the test.

### Example 4

The intumescent fire barrier coating material, as prepared in Example 1, was applied to a piece of Targa leather made by Tecnoconciaria Italia and provided by Lantal Textiles, Langenthal, Switzerland by applying the fire retardant to the unfinished surface of the leather with a roller. The leather including the intumescent fire barrier coating was allowed to cure for 24 hours prior to conducting the following tests.

This sample (e.g., the piece of leather including the intumescent fire barrier coating applied to the unfinished surface) was then subjected to the FAR 25.853, Appendix F, Part IV, Heat Release Test. This test requires a material to have a peak heat release rate (PHRR) of less than or equal to 65 kW/m² and a total heat release rate (THRR) of less than or equal to 65 kWmin/m² at 2 minutes to obtain a passing result. The leather including in the fire retardant material had a PHRR of 52.81 kW/m² and a THRR of 18.80 kWmin/m². As a result, the sample passed the Heat Release Test.

The sample also passed the NBS Smoke Chamber Test in accordance with ABD 0031 under flaming and non-flaming conditions. The piece of leather including the fire retardant material had an average smoke density score of 102 at four minutes under non-flaming conditions and an average smoke density score of 83 at four minutes under flaming conditions. In addition, this sample had the following smoke density scores for the listed gas components:

NBS Smoke Chamber Test in accordance with ABD 0031

| | | | | | | |
|---|---|---|---|---|---|---|
| Gas Type | HCN | CO | NO/NO₂ | SO₂/H₂S | HF | HCL |

(Non-Flaming Conditions - 4 minutes)

| | | | | | | |
|---|---|---|---|---|---|---|
| Ave. Value | 2 | 18 | 11 | 5 | 0 | 1 |
| Max. Value | 150 | 1000 | 100 | 100 | 100 | 150 |

(Flaming Conditions - 4 minutes)

| | | | | | | |
|---|---|---|---|---|---|---|
| Ave. Value | 32 | 136 | 42 | 10 | 0 | 1 |
| Max. Value | 150 | 1000 | 100 | 100 | 100 | 150 |

### Example 5

The intumescent fire barrier coating material as prepared in Example 1 was applied to a piece of 7678 fiberglass cloth to form a test sample. Specifically, a 10 to 15 mils thick coating of the intumescent fire retardant material was deposited on a 18″ by 24′ long piece of 7678 fiberglass cloth using a standard floating knife deposition technique. The test sample was positioned to cover the top interior surface of a standard ASTM E84 Tunnel Test Facility (V-Tech Laboratories, Bronx, N.Y.) and exposed to a flaming fire for 10 minutes.

At the end of the test, the test sample exhibited intumescences or charring up to 6 feet. The test results, computed on the basis of observed flame front advance and electronic smoke density measurements, illustrated that the test sample was a class A material. That is, its rating for flame spread was a 10 on a scale of 0 to 100 and its rating for smoke developed was 105.

### Example 6

A test sample was prepared by applying 8 mils of the intumescent coating material of Example 1 to both sides of a piece of 7678 fiberglass cloth using the floating knife deposition technique. This test sample was place over a standardized FAA required test load for cargo pallets at Ansul Laboratories in Marrinet, Wis. A standard cargo pallet was loaded with approximately 36 cardboard boxes each measuring 18″ on a side and filled with 2.5 pounds of shredded paper.

The load was ignited from the inside using a ni-chrome wire heat source, which then ignited the boxes. Evidence of combustion of the internal fuel load became evident at about 20 minutes and continued for 3 hours. No burn through of the test sample occurred. This test was repeated 3 times using the same test sample. Total test exposure for the test sample was 9 hours and no burn through occurred.

### Example 7

A test sample was prepared by applying 8 mils of the intumescent coating material of Example 1 to both sides of a piece of 7678 fiberglass cloth using the floating knife deposition technique. The test sample was then installed as a rollup door in a standard aluminum aircraft cargo container. That is, the normal rollup door was replaced with the test sample.

At RedBrooks Laboratories in Burlington, Wash., the aluminum cargo container was loaded with approximately 27 18″×18″×18″ cardboard boxes; each filled with 2.5 pounds of shredded paper. The fuel load was ignited with an electronically powered Ni-chrome wire heating element. The fuel was allowed to burn until all fuel was consumed. At no time did the flame breach the fabric door. Temperature ¼″ outside the door never reached greater than 180° F. Temperatures inside the container were monitored by multiple thermocouples. Internal temperatures peaked at 1,5000° F.

This test was performed 3 times using the same door test sample as well as a similar test using 3 gallons of jet fuel (J8), maximum temperature 1,8000° F. At no time did fire penetrate the fire retardant-coated fabric.

### Example 8

A test sample was prepared by applying 8 mils of the intumescent coating material of Example 1 to both sides of a piece of 7678 fiberglass cloth using the floating knife deposition technique. The test sample was stretched at a 90′ angle around a steel rod into an “L” shape with a 12″ horizontal component and a 12″ vertical component. Approximately, two cupfuls of magnesium metal shavings (equal in volume to about 16 ounces of water) were placed along the apex of the bent test sample and ignited with a propane torch at RedBrooks Laboratories in Burlington, Wash.

The resultant fire burned for approximately 10 minutes at a temperature of 2,650° F. There was no burn through of the test sample when the magnesium had finished burning. There was no evidence of flame spread, either vertically or horizontally beyond the borders of the magnesium shavings.

### Example 9

A test sample was prepared by applying 8 mils of the intumescent coating material of Example 1 to the exterior surface of a piece of 7678 fiberglass cloth using the floating knife deposition technique. The test sample was then positioned around a bundle of electrical communication cables such that the interior non-coated sided of the test sample faced the cables and the exterior, intumescent coated sided of the test sample faced the environment. At Bradford Industries in Lowell, Mass., a flame from a methane sourced Bunsen burner was applied to the exterior, intumescent coated test sample. After 5 minutes of direct flame exposure, none of the cables were burned or melted and electrical continuity of the wires remained as before testing. Thermocouples positioned adjacent to the cables and in the interior of the test sample did not exceed 300° F. while thermocouples positioned near the flame measured a temperature of 2000° F.

Cable bundles protected by a piece of non-coated fiberglass and exposed to similar testing exhibited much different results. After 5 minutes of direct exposure to the same Bunsen burner all of the fiberglass insulation was burner through, the cables were melted, and electrical continuity was compromised.

Variations, modifications, and other implementations of what is described herein will occur to those of ordinary skill without departing from the spirit and the scope of the invention. For example, while in some of the embodiments the intumescent fire barrier coating has been described above as coating a fabric forming a covering, wrap, or a gasket, the intumescent fire barrier coating can be applied to other substrates used for any fire barrier purpose. That is, the intumescent fire barrier coating can be applied to fiberglass or other insulative or fibrous substrates (e.g., silica glass cloth) and used as a fire barrier. For example, a fiberglass sheet can be coated on one or more surfaces with the intumescent coating described above and used to prevent fire damage/burn through to structures (e.g., residential buildings, commercial/industrial buildings, storage facilities), equipment (e.g., electrical equipment, military equipment, aviation equipment), or transportation means (e.g., automobiles, trains, aircraft, seacraft). Accordingly, the invention is not to be defined only by the preceding illustrative description.

What is claimed is:

1. A fire protection system for cargo, the fire protection system comprising:
a covering including an exterior surface an interior surface and defining a compartment for housing cargo; and
an intumescent coating disposed on a portion of at least one of the exterior surface or the interior surface of the covering, the intumescent coating as disposed on the covering achieving class A requirements of ASTM E84 standard test and exceeding a three hour burn through test.

2. The fire protection system of claim 1, wherein the covering comprises a tarp comprising woven or non-woven fibers.

3. The fire protection system of claim 2, wherein the woven or non-woven fibers are selected from the group comprising glass fibers, metal fibers, natural fibers, and synthetic fibers.

4. The fire protection system of claim 1, wherein the covering comprises a fabric container door.

5. The fire protection system of claim 1, further comprising:
an insulating layer disposed between the exterior surface and the interior surface of the covering.

6. The fire protection system of claim 1, wherein the intumescent coating reduces transmission of infra-red radiation to the covering.

7. A fire protection system for cargo, the fire retardant protection system comprising:
a covering including an exterior surface an interior surface and defining a compartment for housing cargo; and
an intumescent coating disposed on a portion of at least one of the exterior surface or the interior surface of the covering, the intumescent coating comprising:
a rheology modifier;
a binder cross-linking agent; and
an intumescent base including a binder, a catalyst, a blowing agent, and a charring agent, the intumescent base comprising more than about 65 weight percent of the intumescent coating.

8. The fire protection system of claim 7, wherein the intumescent base comprises about 95 weight percent of the intumescent coating.

9. The fire protection system of claim 7, wherein the blowing agent comprises superfine melamine.

10. The fire protection system of claim 7, wherein the intumescent coating further includes a biocide.

11. The fire protection system of claim 7, wherein the intumescent coating further includes a fungicide.

12. The fire protection system of claim 7, wherein the covering comprises a tarp comprising woven or non-woven fibers.

13. The fire protection system of claim 12, wherein the woven or non-woven fibers are selected from the comprise comprising glass fibers, metal fibers, natural fibers, and synthetic fibers.

14. The fire protection system of claim 7, wherein the covering comprises a fabric container door.

15. The fire protection system of claim 7, further comprising:
an insulating layer disposed between the exterior surface and the interior surface of the covering.

16. The fire protection system of claim 7, wherein the intumescent coating reduces transmission of infra-red radiation to the covering.

17. A fire protection system for structures comprising:
a rollup fabric door defining a front exterior surface and a back exterior surface, the rollup fabric door connected to a mechanism for deploying the rollup fabric door from a rolled up contained state to an unrolled state; and
an intumescent coating disposed on at least one of the front exterior surface or the back exterior surface of the rollup fabric door, the intumescent coating comprising:
a rheology modifier;
a binder cross-linking agent; and
an intumescent base including a binder, a catalyst, a blowing agent, and a charring agent, the intumescent base comprising more than about 65 weight percent of the intumescent coating.

18. The fire protection system of claim 17, wherein the rollup fabric door includes an insulating layer disposed between the front exterior surface and the back exterior surface.

19. The fire protection system of claim 17 further comprising a smoke detector in electrical communication with the mechanism.

20. The fire protection system of claim 17, wherein the intumescent base comprises about 95 weight percent of the intumescent coating.

21. A fire wrap for protecting electrical wires comprising:
a support layer formed of fibers and including an interior surface and an exterior surface;
an intumescent coating disposed on at least one of the interior surface and the exterior surface of the support layer;
an attachment means for securing the support layer about one or more electrical wires, the intumescent coating as disposed on the support layer maintaining electrical continuity of the one or more electrical wires for at least five minutes at 2000° F.

22. A fire gasket for sealing a gap between two adjacent members, the fire retardant gasket comprising:
a fibrous body that when compressed between two adjacent members fills the gap, the fibrous body having an exterior surface;
an intumescent coating disposed on the exterior surface of the fibrous body, the intumescent coating comprising:
a rheology modifier;
a binder cross-linking agent; and
an intumescent base including a binder, a catalyst, a blowing agent, and a charring agent, the intumescent base comprising more than about 65 weight percent of the intumescent coating.

23. The fire gasket of claim 22, wherein the fibrous body comprises a fiberglass form.

24. The fire gasket of claim 22, wherein the intumescent base comprises about 95 weight percent of the intumescent coating.

25. A fire protection system comprising:
a fibrous substrate including an exterior surface an interior surface; and
a fire barrier coating disposed on at least one of the exterior surface or the interior surface of the fibrous substrate, the fire barrier coating comprising a rheology modifier, a binder cross-linking agent, and an intumescent base including a binder, a catalyst, a blowing agent, and a charring agent, the intumescent base comprising more than about 65 weight percent of the fire barrier coating.

26. The fire protection system of claim 25, wherein the intumescent base comprises about 95 weight percent of the intumescent coating.

27. The fire protection system of claim 25, wherein the blowing agent comprises superfine melamine.

28. The fire protection system of claim 25, wherein the intumescent coating further includes a biocide.

29. The fire protection system of claim 25, wherein the intumescent coating further includes a fungicide.

30. The fire protection system of claim 25, wherein the fibrous substrate is selected from the group consisting of a fiberglass sheet, a silica glass cloth, and a polymer reinforced carbon fiber sheet.

31. A fire protection system comprising:
a fibrous substrate including an exterior surface and an interior surface; and
a fire barrier coating disposed on at least one of the exterior surface or the interior surface of the fibrous substrate to form an interface between the fibrous substrate and the fire barrier coating, the fire barrier coating reacting when exposed to a temperature of greater than about 375° F. to form a layer of an infra-red energy reflective material at the interface.

32. The fire protection system of claim 31, wherein the fibrous substrate is selected from the group consisting of a fiberglass sheet, a silica glass cloth, and a polymer reinforced carbon fiber sheet.
